(19) United States
(12) Patent Application Publication
(10) Pub. No.: US 2017/0256150 A1
(43) Pub. Date: Sep. 7, 2017

(54) NETWORK CAMERA

(71) Applicant: SKY LIGHT ELECTRONIC (SHENZHEN) LIMITED CORPORATION, Shenzhen (CN)

(72) Inventors: Chung Man Lai, Shenzhen (CN); Xinjie Mo, Shenzhen (CN); Riming Fang, Shenzhen (CN)

(21) Appl. No.: 15/099,773

(22) Filed: Apr. 15, 2016

(30) Foreign Application Priority Data
Mar. 1, 2016 (CN) 201620160027.1

(51) Int. Cl. G08B 13/196; G08B 13/19

(52) U.S. Cl. CPC G08B 13/19619; G08B 13/1963; G08B 13/19695; G08B 13/19656; G08B 13/19

(57) ABSTRACT

Disclosed is a network camera, which includes a camera assembly, a bottom cover, a top cover assembly fixed to the bottom cover, an alarm assembly and a human body sensor; the camera assembly includes a camera and a rotatable spherical shell which has a fixing cavity for holding the camera; the top cover assembly includes a top cover and a fixing cover fixed to the top cover; the top cover has an upper cavity and a camera hole via which the camera is able to extend out of the top cover; the fixing cover has a lower cavity; the upper cavity and the lower cavity form a spherical cavity together for being rotatably connected with the rotatable spherical shell; and the human body sensor is electrically connected with the camera assembly and the alarm assembly. The present invention achieves energy conservation and has a warning function.

### CROSS-REFERENCE TO RELATED APPLICATIONS

This present invention claims the benefit of Chinese Patent Application No. CN201620160027.1, filed on Mar. 1, 2016; the contents of which are hereby incorporated by reference.

### FIELD OF THE INVENTION

The present invention relates to security equipment and, in particular, it concerns a network camera.

### BACKGROUND OF THE INVENTION

In the existing technology, the camera is needed to be fixed by manually adjusting a fixing device thereof after adjusting an angle for monitoring. Furthermore, the camera is always in a state of working, whether someone is close to it or not. And the existing camera does not have a warning function.

### SUMMARY OF THE INVENTION

An object of the present invention is to provide a network camera so as to overcome the defects of the prior art.

To achieve the above object, there is provided a network camera, which includes a camera assembly and further includes a bottom cover, a top cover assembly fixed to the bottom cover, an alarm assembly and a human body sensor, both of which are provided between the bottom cover and the top cover assembly; the camera assembly includes a camera and a rotatable spherical shell for fixing and surrounding the camera; the rotatable spherical shell has a fixing cavity for holding the camera; the top cover assembly includes a top cover and a fixing cover fixed to the top cover; the top cover has an upper cavity and a camera hole via which the camera is able to extend out of the top cover; the fixing cover has a lower cavity; the upper cavity and the lower cavity form a spherical cavity together for being rotatablely connected with the rotatable spherical shell; and the human body sensor is electrically connected with the camera assembly and the alarm assembly, respectively

Preferably, the human body sensor is a passive infrared sensor.

Preferably, the fixing cover has a regulation hole formed at a bottom thereof via which the camera is able to extend out of the fixing cover.

Preferably, the alarm assembly comprises a loudspeaker, a supporting structure for fixing the loudspeaker and a printed circuit board fixed to the supporting structure; the printed circuit board is electrically connected with the loudspeaker and the human body sensor.

Preferably, the top cover has a plurality of sound holes formed thereon for corresponding to the loudspeaker.

Preferably, the top cover assembly further comprises a decorative ring surrounding outside edge of the top cover.

Preferably, the network camera further includes a fixing base and a power input end provided between the fixing base and the bottom cover; and the alarm assembly, the human body sensor and the camera assembly are all connected with the power input end.

Preferably, the top cover has a sensor hole formed thereon for corresponding to the human body sensor.

Compared with the prior art, the present invention has some beneficial effects as follows: according to the network camera of the present invention, due to providing a rotatable spherical shell to support the camera and a spherical cavity to rotatablely connect with the rotatable spherical shell, the camera can be fixed at a certain angle without any fixing device. Furthermore, the human body sensor can detect whether someone is close to the network camera or not, thereby the camera and the alarm assembly will be controlled to work or not. Thus it achieves energy conservation and a warning function. The network camera of the present invention is provided with reasonable design and good practicability and it can be widely used in the security field.

The present invention will become more clearly by means of the following description combining the accompanying drawings, which are used to illustrate embodiments of the present invention.

### BRIEF DESCRIPTION OF THE DRAWINGS

FIG. 1 is an exploded view of a network camera according to an embodiment of the present invention; and

FIG. 2 is a perspective view of the network camera according to an embodiment of the present invention.

### REFERENCE NUMBERS OF THE DRAWINGS

Network camera 10; camera assembly 1; camera 11; rotatable spherical shell 12; fixing cavity 121; bottom cover 2; fixing base 21; power input end 23; top cover assembly; top cover 31; upper cavity 311; camera hole 312; sound hole 313; sensor hole 314; fixing cover 32; lower cavity 321; regulation hole 322; decorative ring 33; alarm assembly 4; loudspeaker 41; supporting structure 42; printed circuit board 43; human body sensor 5.

### DETAILED DESCRIPTION OF ILLUSTRATED EMBODIMENTS

The technical solutions of embodiments will be clearly and completely described as follows by combining the figures of the embodiments of the present invention, and similar reference numbers in the figures represent similar components. Obviously, the embodiments described as follows are merely parts of embodiments of the present invention, but not the all. Based on the embodiments of the present invention, other embodiments created by one of ordinary skill in the art without creative work, all belong to the scope of protection of the present invention.

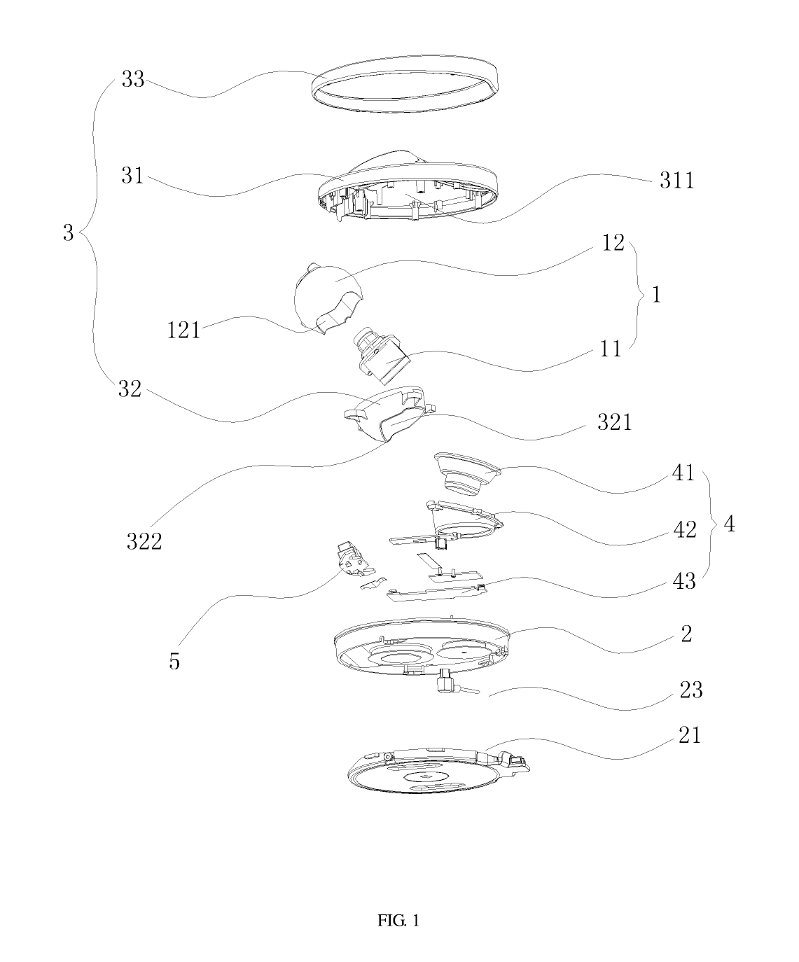

As shown in FIG. 1, the network camera 10 includes a camera assembly 1, a bottom cover 2, a top cover assembly 3 fixed to the bottom cover 2, an alarm assembly 4 and a human body sensor 5. Both of the alarm assembly 4 and the human body sensor 5 are provided between the bottom cover 2 and the top cover assembly 3.

The camera assembly 1 includes a camera 11 electrically connected with the human body sensor 5 and a rotatable spherical shell 12 for fixing the camera 11. The rotatable spherical shell 12 has a fixing cavity 121 for holding the camera. The rotatable spherical shell 12 surrounds the camera 11 and the camera 11 partly extends out of the rotatable spherical shell 12 via the fixing cavity 121. The camera 11 is fixed to the rotatable spherical shell 12 via screws so that it can rotate with the rotatable spherical shell 12.

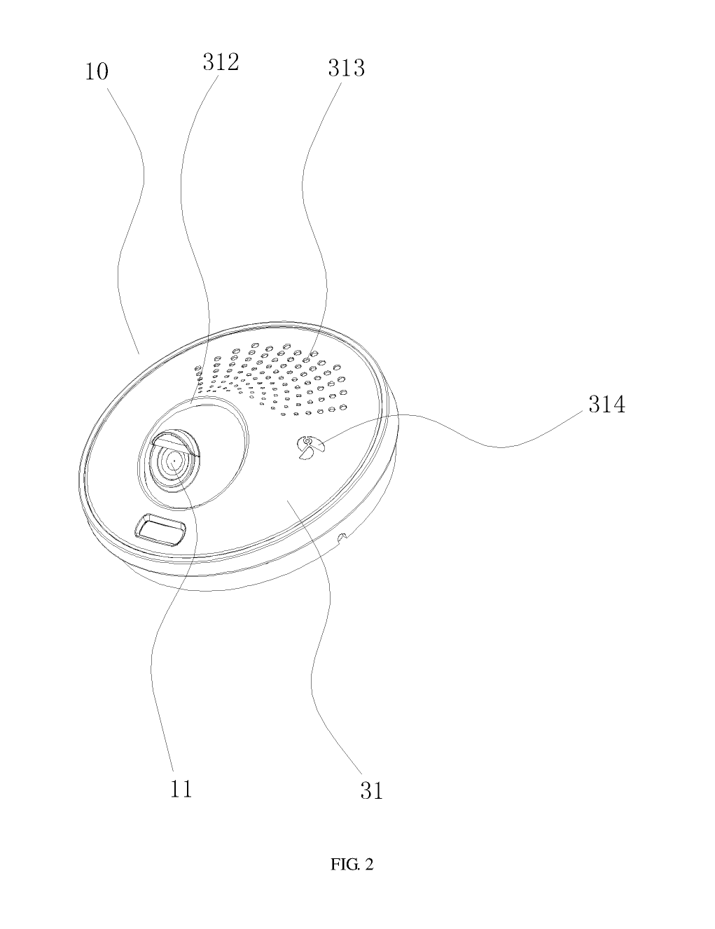

The top cover assembly 3 includes a top cover 31 and a fixing cover 32 fixed to the top cover 31. The top cover 31 has an upper cavity 311 and a camera hole 312 (shown in FIG. 2) via which the camera 11 is able to extend out of the top cover 31. The fixing cover 32 has a lower cavity 321 and a regulation hole 322 formed at a bottom thereof via which the camera 11 is able to extend out of the fixing cover 32. The upper cavity 311 and the lower cavity 321 form a spherical cavity (not shown) together for being rotatablely connected with the rotatable spherical shell 12. The rotatable spherical shell 12 is sandwiched between the top cover 31 and the fixing cover 32 and it can rotate so as to adjust a suitable angle for monitoring.

The alarm assembly 4 includes a loudspeaker 41, a supporting structure 42 for fixing the loudspeaker 41 and a printed circuit board 43 fixed to the supporting structure 42. The printed circuit board 43 is electrically connected with the loudspeaker 41 and the human body sensor 5.

The network camera 10 further includes a fixing base 21 and a power input end 23 provided between the fixing base 21 and the bottom cover 2. The alarm assembly 4, the human body sensor 5 and the camera assembly 1 are all electrically connected with the power input end 23.

The human body sensor 5 is a passive infrared sensor, which is electrically connected with the camera assembly 1 and the alarm assembly 4. When the passive infrared sensor detects that someone is close to the network camera 10, the camera 11 is controlled to work and the alarm assembly 4 is controlled to send an alarm thereby achieving a warning function. Furthermore, the camera 11 is controlled to work only when someone is close to the network camera 10, so as to avoid useless monitoring, thereby reducing energy consumption.

As shown in FIG. 2, the top cover 31 has a plurality of sound holes 313 formed thereon for corresponding to the loudspeaker 41 (shown in FIG. 1) and a sensor hole 314 formed thereon for corresponding to the human body sensor 5 (shown in FIG. 1).

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A network camera, comprising a camera assembly, wherein further comprises a bottom cover, a top cover assembly fixed to the bottom cover, an alarm assembly and a human body sensor, both of which are provided between the bottom cover and the top cover assembly; the camera assembly comprises a camera and a rotatable spherical shell for fixing and surrounding the camera; the rotatable spherical shell has a fixing cavity for holding the camera; the top cover assembly comprises a top cover and a fixing cover fixed to the top cover; the top cover has an upper cavity and a camera hole via which the camera is able to extend out of the top cover; the fixing cover has a lower cavity; the upper cavity and the lower cavity form a spherical cavity together for being rotatablely connected with the rotatable spherical shell; and the human body sensor is electrically connected with the camera assembly and the alarm assembly.

2. The network camera according to claim 1, wherein the human body sensor is a passive infrared sensor.

3. The network camera according to claim 1, wherein the fixing cover has a regulation hole formed at a bottom thereof via which the camera is able to extend out of the fixing cover.

4. The network camera according to claim 1, wherein the alarm assembly comprises a loudspeaker, a supporting structure for fixing the loudspeaker and a printed circuit board fixed to the supporting structure; and the printed circuit board is electrically connected with the loudspeaker and the human body sensor.

5. The network camera according to claim 4, wherein the top cover has a plurality of sound holes formed thereon for corresponding to the loudspeaker.

6. The network camera according to claim 1, wherein the top cover assembly further comprises a decorative ring surrounding outside edge of the top cover.

7. The network camera according to claim 1, wherein further comprises a fixing base and a power input end provided between the fixing base and the bottom cover; and the alarm assembly, the human body sensor and the camera assembly are all electrically connected with the power input end.

8. The network camera according to claim 1, wherein the top cover has a sensor hole formed thereon for corresponding to the human body sensor.
